(19) United States
(12) Patent Application Publication
(10) Pub. No.: US 2007/0172794 A1
(43) Pub. Date: Jul. 26, 2007

(54) Device for Forming Bone Bed for Dental Implant

(76) Inventors: Michail A. Borik, Moscow (RU); Vladimir P. Voitzitzkii, Moscow (RU); Maria A. Vishnyakova, Moscow (RU); Elena E. Lomonova, Moscow (RU); Vyacheslav V. Osiko, Moscow (RU); Lev V. Chilikin, Moscow (RU)

Correspondence Address: UNITED STATES DEPARTMENT OF ENERGY, 1000 INDEPENDENCE AVENUE, S.W., ATTN: GC-62 (HQ) MS 6F-067, WASHINGTON, DC, 20585-0162, US

(21) Appl. No.: 11/624,427

(22) Filed: Jan. 18, 2007

(30) Foreign Application Priority Data
Jan. 26, 2006 (RU) 2006102210

(51) Int. Cl. A61C 3/02

(52) U.S. Cl. 433/165

(57) ABSTRACT

A single-stage dental implant with a wavy surface is composed of a crystal of partially stabilized zirconium dioxide with a nanostructure having a crystallographic axis “100” coinciding with an axis of the implant, ithasan intraosteal part with a wavy surface and its vertical profile includes concave arcs of a circle with reducing radius, wherein a tangent to the circles forms with the axis of the implant an angle 8-10°, a transition from one concave arc to another is smoothed by an arc, a vertical profile of the peryosteal part is a concave of a circle arc, and ¼ of the peryosteal part adjoining the intraoral part is a truncated cone with a generatrix forming with the axis an angle 8-20°.

### CROSS-REFERENCE TO A RELATED APPLICATION

The invention described and claimed hereinbelow is also described in Russian Patent Application 2006102210 filed on Jan. 26, 2006. This Russian Patent Application, whose subject matter is incorporated here by reference, provides the basis for a claim of priority of invention under 35 U.S.C. 119(a)-(d).

### BACKGROUND OF THE INVENTION

The present invention relates to medicine, in particular to surgical and orthopedic dentistry, and can be used for implantation.

A dental drill is disclosed in RU 1,223,638, which has a rod and a head with cutting teeth. In order to increase corrosion strength the head is formed with a chromium coating. Another dental drill is disclosed in RU 1,438,757 in which in order to increase wear-resistance the working surfaces are formed with a diamond coating. The use of corrosion-resistant coating increases operational reliability and expands service life of dental drills. However, the coatings have low strength and plasticity properties. Therefore, the mechanical properties of the drill which are determined by alternative or single loading, and in particular its impact viscosity, low-cycle strength and fatigue strength are decreased and the service life of the drill is reduced. The dental drill disclosed in RU 2007967 has a rod and a head with a cutting teeth and a coating, that is formed to penetrate into the structure of the head due to inclusion into the coating of dispersed phase in form of ultra-dispersed diamonds. This reduces local destruction of the dental drill due to exclusion of non uniformity of the coating of the cutting teeth of the head.

Another problem of dental drills is heating at high rotary speeds, (up to 10,000 revolutions per minute) which can cause thermal burn of bone tissues of a patient. The dental drill disclosed in RU 2,151,570 is a cylindrical body which has a tail part, a working part with grooves and cutting edges, and a passage inside the cylindrical body formed with a variable diameter. It reduces the disadvantages of dental instruments disclosed in U.S. Pat. No. 5,575,651, U.S. Pat. No. 5,261,81 and DE 2,331,023. When a uniform and constant flow of cooling liquid, for example water is provided, a significant reduction of probability of thermal damage of a bone tissue to be treated can be achieved.

U.S. Pat. No. 6,659,769 discloses a mill for the implant. It is formed as a plate with a shaped head and cutting grooves which partially eliminates the problem of overheating and provides withdrawal of bone chips.

A high speed of rotation of the drill can cause also uncontrolled removal of a bone material, which depends on a force applied to the head. RU 2,019,151 provides an increase of safety of treatment and simplification of the design due to a cutting blade extending above the head and a certain ratio of the angle of inclination of a groove to an axis of the drill and an angle of opening of the groove in a cross-section as well as a ratio of an area of groove cross-section to an area of head cross-section. This drill operates with high rotary speed not less than 800 revolutions per minute, which however represents its disadvantage. The drill provides removal of material in a closed manner: During one revolution it removes a material by a quantity which is not more than a height of extension above the support of the cutting element. This prevents a deeper penetration and avoids significant pain. The tail part, the neck and the head are formed of a composite material, and the cutting element can be composed of diamond. However, the use of different materials reduces the strength and reliability of the drill, which is a disadvantage.

Because of the use of new materials for implants, such as partially stabilized zirconium dioxide with a nanostructure and implants with certain geometry as disclosed in our patent application of Russian Federation 2005102197, it is necessary to provide a device for forming a bone bed with a surface corresponding to the surface of the implant.

### SUMMARY OF THE INVENTION

Accordingly, it is an object of the present invention to provide a device for forming a bone bed for a dental implant, which eliminates the disadvantages of the prior art and is a further improvement of the existing devices of this type.

In keeping with these objects and with others which will become apparent hereinafter, one feature of the present invention resides, briefly stated, in a device for forming a bone bed for dental implants, comprising a forming element having a tail part, a connecting neck and a head with cutting elements, said head being composed of a crystal of partially stabilized zirconium dioxide with a nanostructure and formed as a plate of revolution with a crystallographic axis “100” coinciding with an axis of said element, said plate having two wide faces with a vertical profile formed by circular arcs that are convex relative to said axis of said element with a radius increasing in a direction of movement of the device, with a transition from one of said convex circular arcs to another of said convex circular arcs being smoothed by a circular arc that is concave relative to said axis of said element, with grooves provided along said concave circular arcs at opposite sides of each of said wide faces and forming with narrow faces of said plate a first group and a second group of cutting elements, said head having an end part formed as a truncated sphere and including a circular segment from one side of a wide face, with a groove provided at an opposite side of said plate on said end part of the head and formed by two planes located at an angle of 90° relative to one another and extending through a center of said truncated sphere and two points of two diagonally arranged ribs of said plate.

When the device is designed in accordance with the present invention it has greater strength, it reduces risk of thermal burns, it provides efficient abutment of the implant against the bone bed.

The whole head is composed of a high strength material, namely a crystal of partially stabilized zirconium dioxide with nanostructure, allowing to operate with low rotary speeds not more than 200 revolutions per minute, excluding risk of thermal burns, with the shape of the plate and profile of the groove preventing accumulation of bone chips. In addition, anisotropy of the crystal of the partially stabilized zirconium dioxide is used, or in other words the coincidence of the crystallographic axis “100” and the axis of the device for forming of a bone bed. Congruency of the bone bed for the implant in accordance with the Russian Patent Application 2005102197/14 of the same inventors is obtained by selection of initial transverse sizes of the plate, which correspond to the size of the used implant. It is possible to use workpieces of the implants disclosed in the Russian patent application 2005102197 for manufacture of the device for forming a bone bed in accordance with the present invention.

The novel features of which are considered characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a device for forming a bone bed for a dental implant in accordance with the present invention;

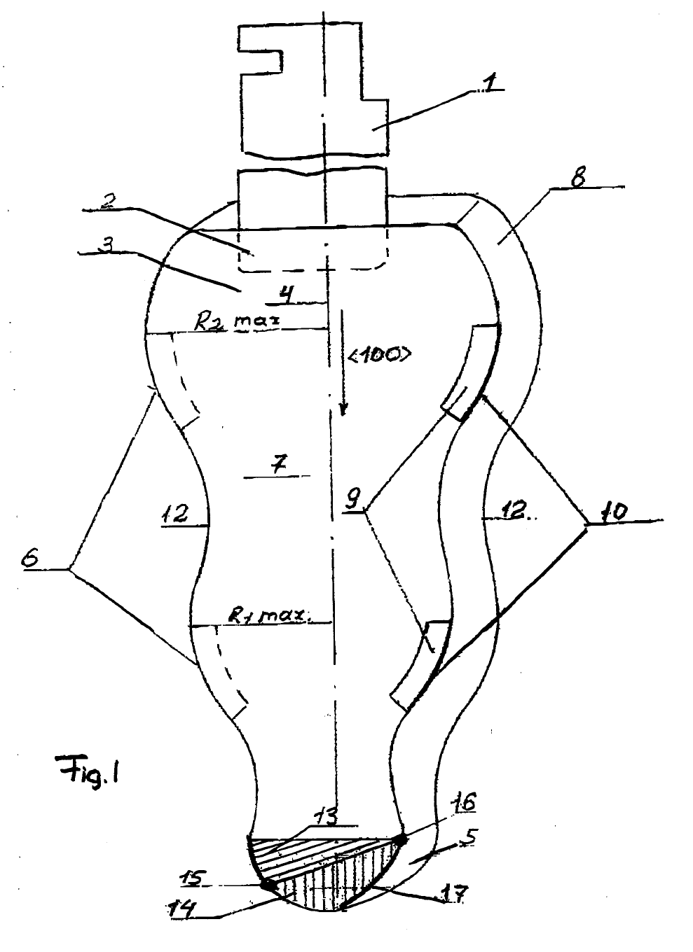

FIG. 2 is a view showing a head of the device for forming a bone bed for the dental implant in accordance with the present invention as seen from an opposite side; and

FIG. 3 is a top view of the device for forming a bone bed.

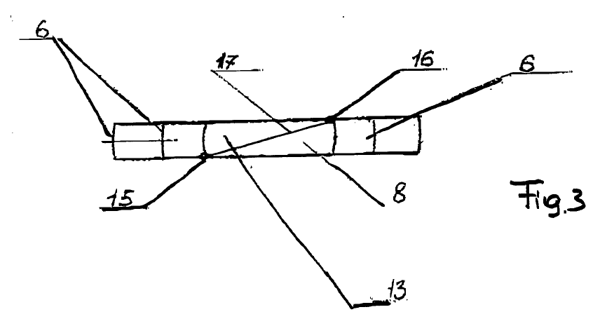

### DESCRIPTION OF THE PREFERRED EMBODIMENTS

The device for forming a bone bed for a dental implant in accordance with the present invention has a tail part 1, a connecting neck 2, and the head 3. It has an axis which is identified with reference numeral 4. A part of the head which is formed as a truncated sphere is identified with reference numeral 5.

The device has arcs 6 of circles which are convex relative to the axis. It further has wide faces of the head 7, narrow faces of the head 8, and grooves 9. The device further has first and second groups of cutting elements identified with 10 and 11. It also has arcs 12 of circles which are concave relative to the axis of the device. The device further has a groove, two surfaces 13 and 14 located at an angle of 90° relative to one another and passing through a center of the truncated sphere, and two points 15 and 16 of two diagonal ribs of the plate.

A third cutting element 17 is formed by intersection of the surface 14 with the spherical surface of the narrow face 8 of the end part of the head. It is advisable to use workpieces of the implant disclosed in Russian patent application 2005102197 for making the device for forming the bone bed in accordance with the present invention. For this purpose it is necessary to cut the workpiece of the implant along two parallel surfaces, which are also parallel to the axis of the device.

The tail part 1 and the connecting neck 2 can be composed of a tool steel and formed as a standard tail of the dental drill. The head 3 is formed as integral one-piece part and composed of a crystal of partially stabilized zirconium dioxide with a nanostructure. In the proposed embodiment, the head can be subdivided into three parts and has, in accordance with the size of the implant, a length of 7 mm and a thickness of 2 mm. Grooves 7 are formed along the arcs 6 of the circles from opposite sides of each wide face of the plate. The grooves 7 are made by drilling to a depth of 0.15 mm, with a diameter of drill of 0.25 mm.

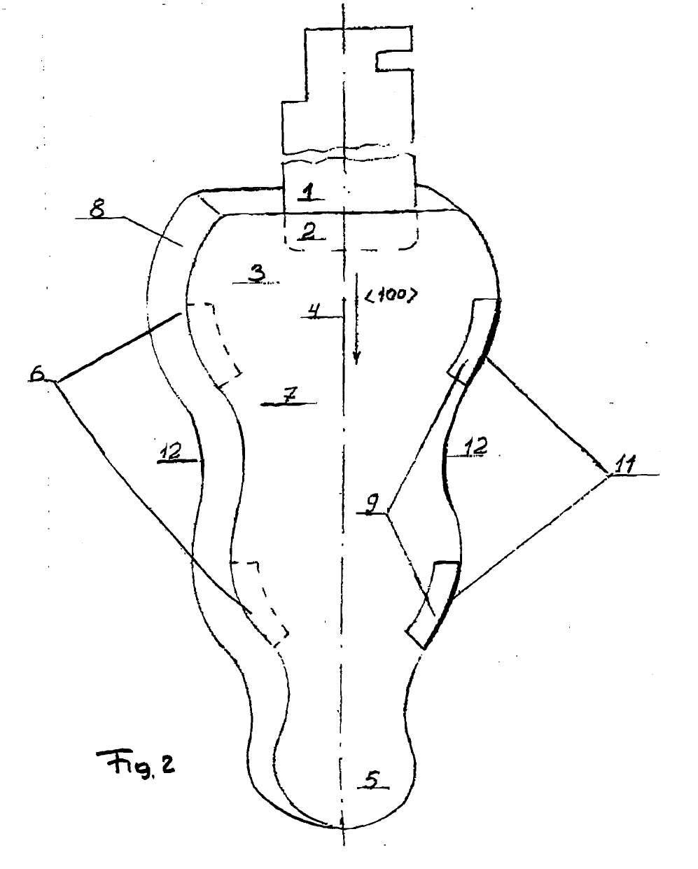

These grooves form a wall of the narrow surface, first and second grooves of the cutting elements 10 and 11. Between the narrow face of the plate and a tangent to the circle of the groove, an angle of sharpening is formed. The grooves can be formed along the direction of working movement of the plate from the beginning of the convex arcs 6 to a maximum horizontal cord of the corresponding circle (R1 max and R2 max in FIG. 2). This part during rotation of the plate is a working part.

A device for forming a bone bed operates in the following manner. First a guide passage is formed for the length of the implant. The first drilling of the bone tissue is made by a drill composed of a tool steel. In order to minimize contamination (i.e., spreading infections) oxide zirconium is sprayed on the surface of the drill. The diameter of the drill is selected to be equal to the diameter of the sphere of the end part of the head of the device, which in turn is equal to the diameter of the semi-sphere of the apical end of the implant. In the formed passage, the end part 5 of the head 3 for forming a bone bed is introduced. During rotation of the plate first the cutting elements of the head with the smaller diameter R1 operate, and during the advanced movement of the plate along the passage the cutting elements of the first and second groups 11 and 12 operate. When the head reaches the bottom of the passage, the third cutting element 13 of the end part of the head starts working. The bone bed is formed this way, so that its surface coincides with the surface of the implant and therefore the process of installation of the implant is facilitated.

The proposed device for forming a bone bed has a higher strength due to the use of the material, coincidence of the crystallographic axis “100” of the partially stabilized zirconium dioxide with the axis of the device. The proposed device for forming a bone bed has a lower risk of thermal burns due to operation at low speeds, in particular 200 revolutions per minute, and a simplified discharge of any bone chips. Due to the fact that the plate during rotation forms a stepped cylinder whose main part includes cavities, the discharge of bone chips is facilitated. The shape of the head of the device for forming a bone bed provides congruency of the surface of the implant disclosed in Russian patent application 20055102197. The device provides a controlled removal of a bone tissue.

It will be understood that each of the elements described above, or two or more together, may also find a useful application in other types of constructions differing from the type described above.

While the invention has been illustrated and described as embodied in a device for forming bone bed for dental implant, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A device for forming a bone bed for dental implants, comprising a forming element having a tail part, a connecting neck and a head with cutting elements, said head being composed of a crystal of partially stabilized zirconium dioxide with a nanostructure and formed as a plate of revolution with a crystallographic axis “100” coinciding with an axis of said element, said plate having two wide faces with a vertical profile formed by circular arcs that are convex relative to said axis of said element with a radius increasing in a direction of movement of the device, with a transition from one of said convex circular arcs to another of said convex circular arcs being smoothed by a circular arc that is concave relative to said axis of said element, with grooves provided along said concave circular arcs at opposite sides of each of said wide faces and forming with narrow faces of said plate a first group and a second group of cutting elements, said head having an end part formed as a truncated sphere and including a circular segment from one side of a wide face, with a groove provided at an opposite side of said plate on said end part of the head and formed by two planes located at an angle of 90° relative to one another and extending through a center of said truncated sphere and two points of two diagonally arranged ribs of said plate.
